(19) United States
(12) Patent Application Publication
(10) Pub. No.: US 2016/0210726 A1
(43) Pub. Date: Jul. 21, 2016

(54) METHOD AND DEVICE FOR ADJUSTING PAGE DISPLAY

(71) Applicant: Xiaomi Inc., Beijing (CN)

(72) Inventors: Mingyang YU, Beijing (CN); Weixing LI, Beijing (CN); Yuzhen WAN, Beijing (CN)

(73) Assignee: Xiaomi Inc.

(21) Appl. No.: 14/986,201

(22) Filed: Dec. 31, 2015

(30) Foreign Application Priority Data
Jan. 15, 2015 (CN) 201510020768.X

(51) Int. Cl. G06T 3/40; G09G 5/373; G09G 5/00; G06F 3/0484; G06F 3/0482

(52) U.S. Cl. CPC G06T 3/40; G06F 3/04845; G06F 3/04842; G06F 3/0482; G09G 5/005; G09G 5/373; G09G 2354/00; G09G 2340/04

(57) ABSTRACT

A method for adjusting page display on a terminal includes acquiring, according to a user demand on page display, a first logic density corresponding to the user demand. The first logic density is defined in an operating system of the terminal. The method further includes acquiring a second logic density of an application program to be displayed. The second logic density is defined in the application program. The method also includes determining a scaling factor of elements in a page of the application program according to the first logic density and the second logic density, and scaling the elements in the page according to the scaling factor.

The present application is based upon and claims priority to Chinese Patent Application No. CN201510020768.X, filed Jan. 15, 2015, the entire contents of which are incorporated herein by reference.

### TECHNICAL FIELD

The present disclosure relates to internet technology and, more particularly, to a method and device for adjusting page display.

### BACKGROUND

A native Android system selects a logic density, also referred to as a “screen logic density,” for a terminal according to a resolution of a display screen of the terminal. As a result, the same logic density may be selected for mobile phones having different physical screen sizes but the same resolution. For example, a mobile phone having a 5-inch screen and a mobile phone having a 5.5-inch screen may have the same logic density of xxhdpi (480 dpi). When an application program having an xxhdpi picture is installed in the two mobile phones, in visual effects, the xxhdpi picture on the 5.5-inch mobile phone would appear to be 1.1 times larger than that on the 5-inch mobile phone (5.5/5=1.1). As such, using the conventional Android system, a mobile phone having a larger screen size may not be able to display more contents, such as more app icons on one page.

In conventional technologies, mobile phone manufacturers utilize different picture adjusting methods for mobile phones having different screen sizes. A picture may be stretched horizontally or longitudinally as desired while maintaining the pixel size, to satisfy the need to accommodate various resolutions. However, such picture adjusting methods can only adjust page layouts for pre-installed application programs such as system application programs, and cannot adjust for third party application programs installed by the users, and cannot adjust layouts for certain devices.

### SUMMARY

In accordance with the present disclosure, there is provided a method for adjusting page display on a terminal. The method includes acquiring, according to a user demand on page display, a first logic density corresponding to the user demand. The first logic density is defined in an operating system of the terminal. The method further includes acquiring a second logic density of an application program to be displayed. The second logic density is defined in the application program. The method also includes determining a scaling factor of elements in a page of the application program according to the first logic density and the second logic density, and scaling the elements in the page according to the scaling factor.

Also in accordance with the present disclosure, there is provided a terminal, including a processor and a memory storing instructions. The instructions, when executed by the processor, cause the processor to acquire, according to a user demand on page display, a first logic density corresponding to the user demand. The first logic density is defined in an operating system of the terminal. The instructions further cause the processor to acquire a second logic density of an application program to be displayed. The second logic density is defined in the application program. The instructions also cause the processor to determine a scaling factor of elements in a page of the application program according to the first logic density and the second logic density, and scale the elements in the page according to the scaling factor.

Also in accordance with the present disclosure, there is provided a non-transitory computer-readable storage medium storing instructions that, when being executed by a processor of a terminal, cause the terminal to acquire, according to a user demand on page display, a first logic density corresponding to the user demand. The first logic density is defined in an operating system of the terminal. The instructions further cause the terminal to acquire a second logic density of an application program to be displayed. The second logic density is defined in the application program. The instructions also cause the terminal to determine a scaling factor of elements in a page of the application program according to the first logic density and the second logic density, and scale the elements in the page according to the scaling factor.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a flow chart of a method for adjusting page display according to an exemplary embodiment.

FIG. 2 is a flow chart of a method for adjusting page display according to another exemplary embodiment.

FIG. 3 is a flow chart of a method for adjusting page display according to another exemplary embodiment.

FIG. 4 is a flow chart of a method for adjusting page display according to another exemplary embodiment.

FIG. 5 is a block diagram of a device for adjusting page display according to an exemplary embodiment.

FIG. 6 is a block diagram of a device for adjusting page display according to another exemplary embodiment.

FIG. 7 is a block diagram of a device for adjusting page display according to another exemplary embodiment.

FIG. 8 is a block diagram of a device for adjusting page display according to another exemplary embodiment.

FIG. 9 is a block diagram of a device for adjusting page display according to another exemplary embodiment.

FIG. 10 is a block diagram of a device applied for adjusting page display according to another exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the disclosure. They are merely examples of devices and methods consistent with aspects related to the invention as recited in the appended claims.

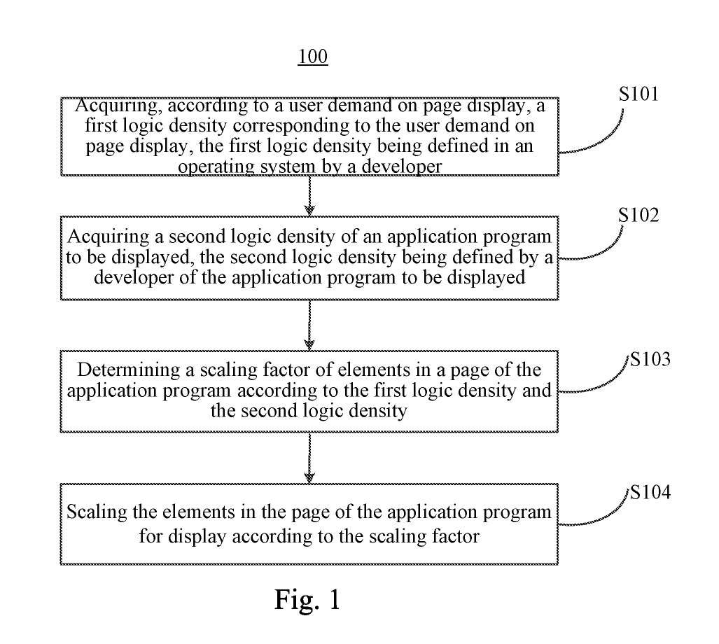

FIG. 1 is a flow chart of a method 100 for adjusting page display according to an exemplary embodiment. The method 100 can be implemented in a device for a system program or other application programs. As shown in FIG. 1, at S101, according to a user demand on page display, a first logic density corresponding to the user demand on page display is acquired. The first logic density can be defined in an operating system by a developer. For example, the first logic density can be defined in the operating system by a deep-customization developer of the Android system, instead of a logic density defined in a native Android system. For example, several default screen logic densities, such as 160 dpi (mdpi), 240 dpi (hdpi), 320 dpi (xhdpi), 480 dpi (xxhdpi), and 640 dpi (xxxhdpi), are defined in the native Android operating system.

As an example, for a mobile terminal having a display screen with a resolution of 640, the native Android operating system may choose a logic density of xxxhdpi by default, without taking into consideration the physical size of the screen. In contrast, according to the present disclosure, the logic densities are defined by the deep customization developer of the Android system, and the logic density is not selected in accordance with the resolution of the mobile phone. Rather, various self-defined logic densities can be selected according to user demands about page display.

In some embodiments, the user demand about page display may include a setting, e.g., by a user, of a size of a page layout, also referred to as a “layout size.” For example, some users, such as older people, may prefer larger elements displayed in a page, while some users may prefer smaller elements displayed in a page so that more contents can be displayed. In some embodiments, setting options can be included in the operating system to provide different layout sizes for the users to select.

For example, options for page layouts, also referred to as “page-layout options,” can be provided when the device is turned on or be provided in a “Settings” menu. The page-layout options may include several options such as “small,” “default,” “medium,” “large,” “super large,” and so on, each of which may correspond to a different scaling factor. When the user wishes to adjust a page layout, the user may click on one of the options. The page layout can then be adjusted according to the scaling factor corresponding to the selected option.

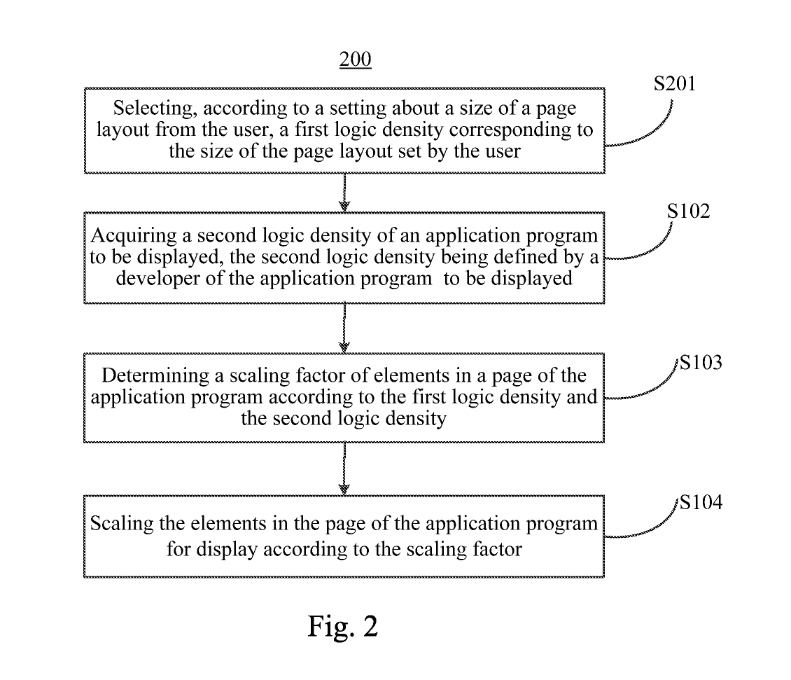

FIG. 2 is a flow chart of a method 200 according to another exemplary embodiment. The method 200 is similar to the method 100. According to the method 200, acquiring the first logic density corresponding to the user demand on page display (S101 in FIG. 1) includes selecting, according to a setting from the user of a layout size, the first logic density corresponding to the layout size set by the user (S201 in FIG. 2).

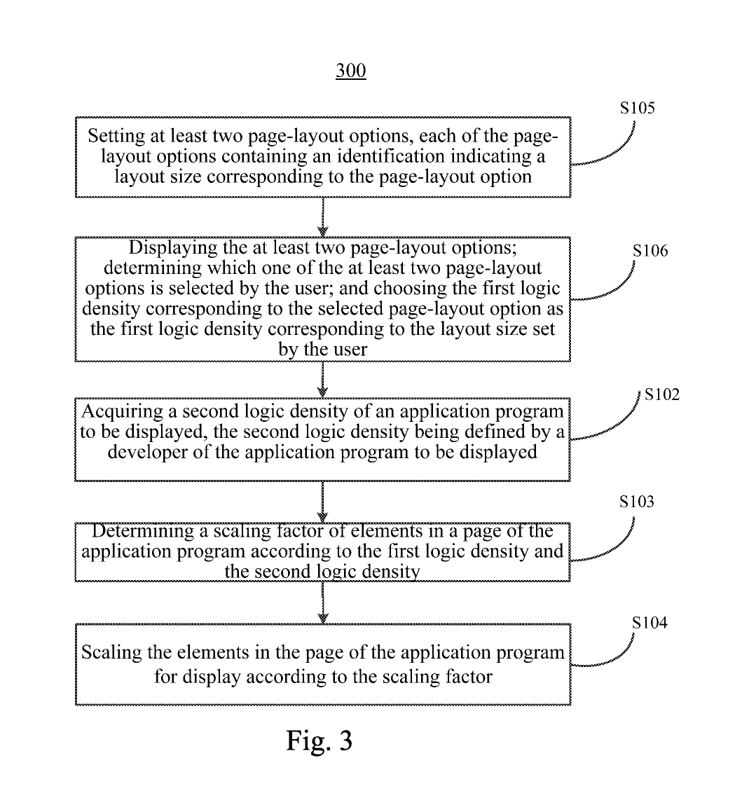

FIG. 3 is a flow chart of a method 300 according to another exemplary embodiment. The method 300 is similar to the method 200. According to the method 300, at S105, at least two page-layout options are set and the first logic density corresponding to each of the at least two layout options is set and stored. Each of the page-layout options contains an identification indicating a layout size corresponding to the page-layout option.

Further, to select the first logic density corresponding to the layout size set by the user (S201 in FIG. 2), according to the method 300, at S106, the at least two page-layout options are displayed, the one of the at least two page-layout options which is selected by the user is determined, and the first logic density corresponding to the selected page-layout option is chosen as the first logic density corresponding to the layout size set by the user.

In some embodiments, the user demand about page display may include a requirement, e.g., by a user, for a physical size of page elements displayed on a screen. As discussed above, physical sizes of screens having the same resolution may be different. For example, two mobile phones with models X1 and X2 may have the same screen resolution of 480 dpi, while the physical size of the screen of model X1 is 5 inches and the physical size of the screen of model X2 is 5.5 inches. In the native Android system, the same logic density will be selected for both X1 and X2. As a result, a page on X2 with the 5.5-inch screen will be enlarged. In practical application, however, the user may wish that the same element displayed on the screens of different sizes has the same physical size, such that the larger screen can be more effectively utilized and the user can have a better visual feeling.

Accordingly, in some embodiments, the logic density mechanism in the native system is modified to provide different logic densities for mobile phones of different models or of different sizes, such that the same element can be displayed with the same physical size on screens of different sizes.

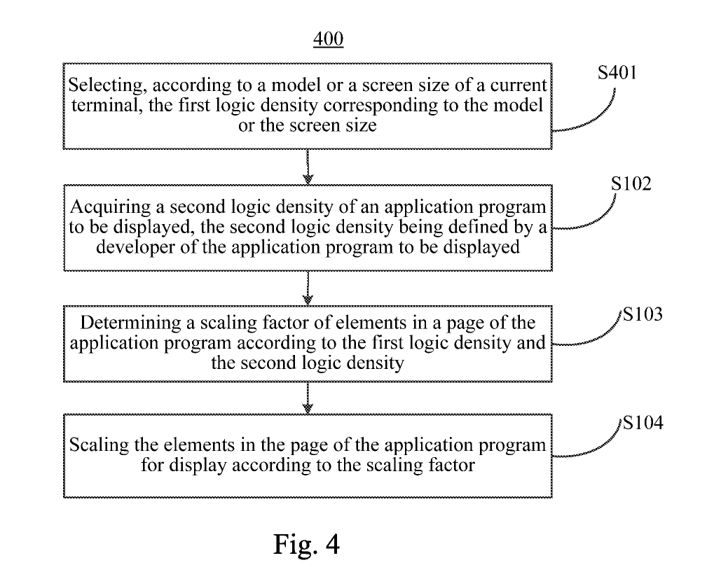

FIG. 4 is a flow chart of a method 400 according to another exemplary embodiment. The method 400 is similar to the method 100. According to the method 400, acquiring the first logic density corresponding to the user demand on page display (S101 in FIG. 1) includes selecting, according to a model of a current terminal or a size of a display screen of the current terminal, the first logic density corresponding to the model of the current terminal or the size of the display screen (S401 in FIG. 4).

Referring to any one of FIGS. 1, 2, 3, and 4, at S102, a second logic density of an application program to be displayed is acquired. The second logic density is defined by a developer of the application program to be displayed, and may also be referred to as a “resource density.” The second logic density can be set when a user develops an application program. For example, the second logic density can be 480 dpi.

At S103, a scaling factor for elements in a page of the application program is determined according to the first logic density and the second logic density. In some embodiments, the scaling factor, m, of the elements in the page of the application program is calculated based on the following formula:

$$m = \frac{X}{Z} ,$$

where m denotes the scaling factor of the elements in the page of the application program, X denotes the first logic density, and Z denotes the second logic density.

For example, in a device with a screen size of 5.5 inches, if the first logic density is 480 dpi and the second logic is 400 dpi, then the scaling factor m of the elements in the page of the application program is m=480 dpi/400 dpi=1.2.

At S104, the elements in the page of the application program are scaled for display according to the scaling factor. For example, if the calculated scaling factor is 1.2, then the elements in the page are enlarged by 1.2 times.

Thus, according to the present disclosure, at least two methods for selecting a logic density are provided (S201 in FIG. 2 and S401 in FIG. 4). Modifying the logic density selection mechanism of the native system according to the embodiments of the present disclosure can result in various effects.

For example, as described above, for each layout size, a corresponding logic density can be set. Thus, the user can easily adjust the layout size by changing the first logic density.

Further, as described above, the first logic density can be set according to the model of the terminal or the screen size of the terminal, instead of using the default logic density in the native system. Thus, according to the present disclosure, the logic density can correspond to the model or the screen size of the terminal, instead of merely corresponding to the resolution of the screen. By selecting a logic density according to the model or the screen size of the terminal, an optimal logic density corresponding to the model or the screen size of the terminal can be acquired. As a result, sizes of elements in the displayed pages on different terminals can be the same, which improves the visual feeling of the user. Moreover, more contents, rather than merely an enlarged page, can be displayed on a large screen as compared to a smaller screen having the same resolution.

In some embodiments, the scaling mainly applies to elements that are displayed in accordance with a logic density in a page of an application program, rather than the whole displayed resources of the application program. Therefore, the scaling will not affect the reasonable layout of the displayed page.

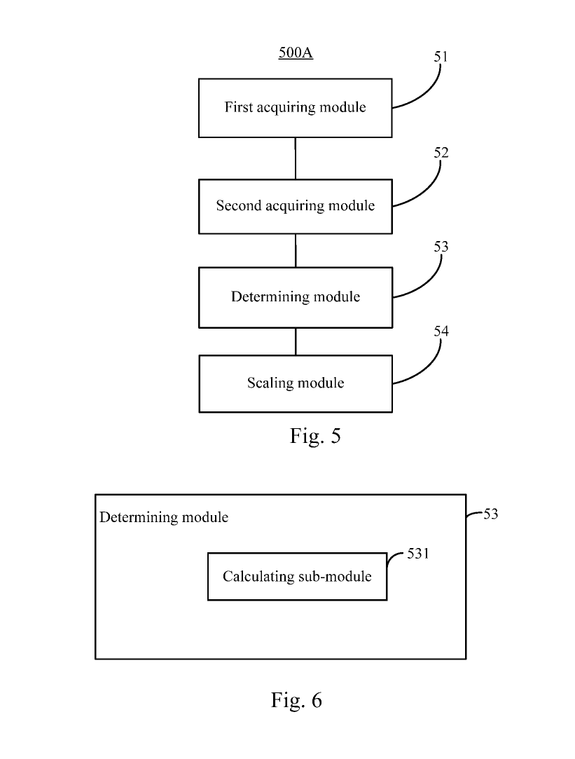

FIG. 5 is a block diagram of a device 500A for adjusting page display according to an exemplary embodiment. As shown in FIG. 5, the device 500A includes a first acquiring module 51, a second acquiring module 52, a determining module 53, and a scaling module 54.

The first acquiring module 51 is configured to acquire, according to a user demand on page display, a first logic density corresponding to the user demand on page display. The first logic density is defined in an operating system by a developer.

The second acquiring module 52 is configured to acquire a second logic density of an application program to be displayed. The second logic density is defined by a developer of the application program to be displayed.

The determining module 53 is configured to determine a scaling factor of elements in a page of the application program according to the first logic density and the second logic density.

The scaling module 54 is configured to scale the elements in the page of the application program for display according to the scaling factor.

In some embodiments, as shown in FIG. 6, the determining module 53 includes a calculating sub-module 531 configured to calculate the scaling factor m of the elements in the page of the application program based on the following formula:

$$m = \frac{X}{Z} ,$$

where m denotes the scaling factor of the elements in the page of the application program, X denotes the first logic density, and Z denotes the second logic density.

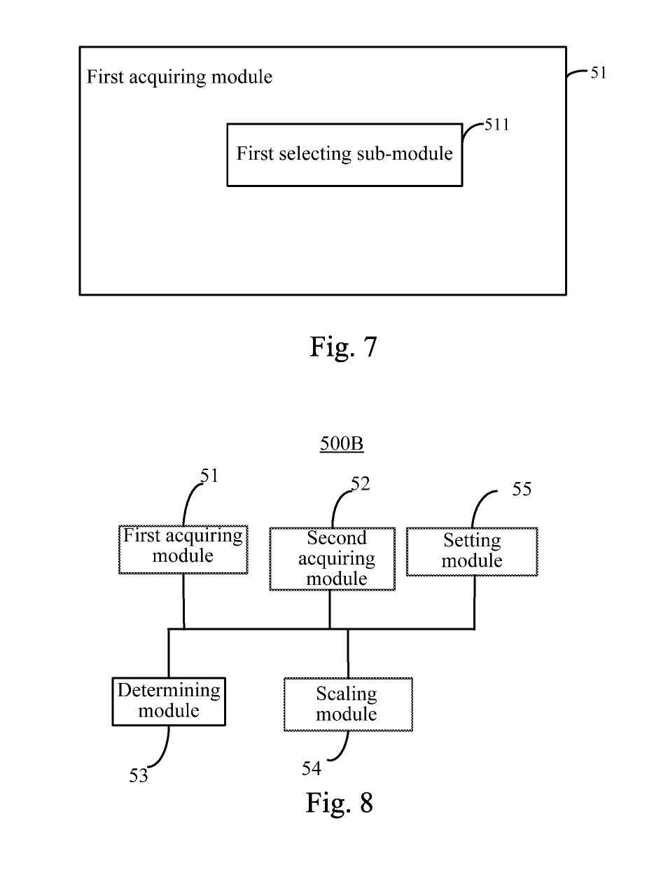

In some embodiments, as shown in FIG. 7, the first acquiring module 51 includes a first selecting sub-module 511 configured to select, according to a setting for a layout size from a user, the first logic density corresponding to the layout size set by the user.

FIG. 8 is a block diagram of a device 500B according to another exemplary embodiment. As shown in FIG. 8, the device 500B includes the first acquiring module 51, the second acquiring module 52, the determining module 53, the scaling module 54, and a setting module 55. The setting module 55 is configured to set at least two page-layout options. Each of the page-layout options contains an identification indicating a layout size corresponding to the page-layout option. The setting module 55 is further configured to set and store the first logic density corresponding to each of the at least two page-layout options.

In these embodiments, the first selecting sub-module 511 in the first acquiring module 51 is further configured to display the at least two page-layout options, determine which one of the at least two page-layout options is selected by the user, and choose the first logic density corresponding to the selected page-layout option as the first logic density corresponding to the layout size set by the user.

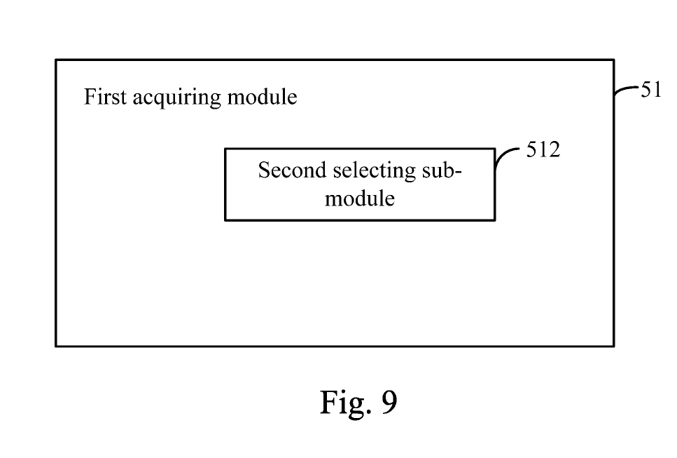

In some embodiments, as shown in FIG. 9, the first acquiring module 51 includes a second selecting sub-module 512 configured to select, according to a model or a screen size of a current terminal, the first logic density corresponding to the model or the screen size of the current terminal.

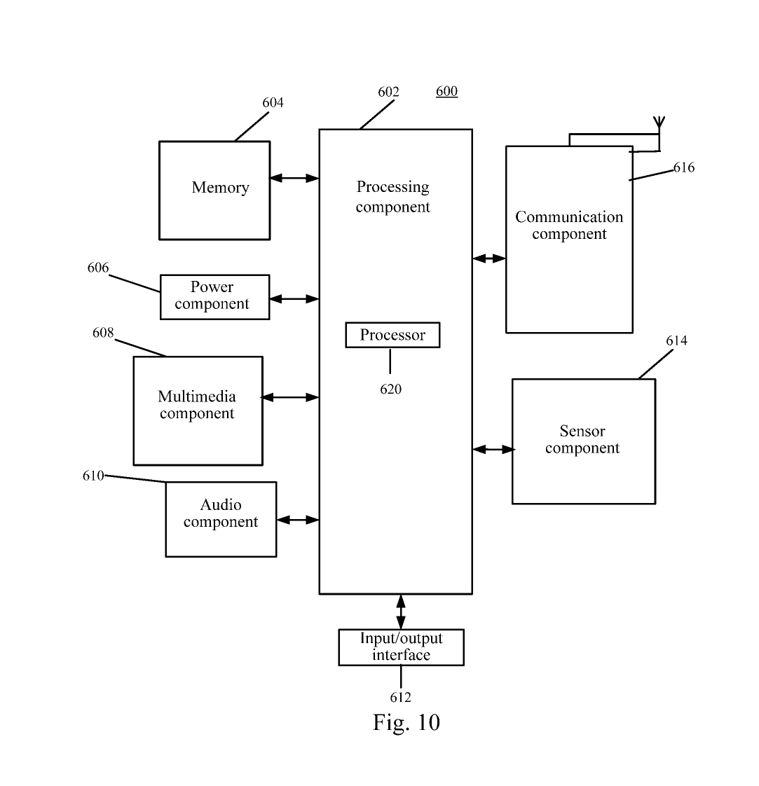

FIG. 10 is a block diagram of a device 600 for adjusting page display according to an exemplary embodiment. The device 600 can be implemented, for example, in a terminal device, such as a mobile phone, a computer, a digital broadcast terminal, a messaging device, a gaming console, a tablet, a medical device, exercise equipment, a personal digital assistant, or the like.

Referring to FIG. 10, the device 600 includes one or more of the following components: a processing component 602, a memory 604, a power component 606, a multimedia component 608, an audio component 610, an input/output (I/O) interface 612, a sensor component 614, and a communication component 616.

The processing component 602 typically controls overall operations of the device 600, such as the operations associated with display, telephone calls, data communications, camera operations, and recording operations. The processing component 602 may include one or more processors 620 to execute instructions to perform all or part of the methods consistent with the present disclosure. Moreover, the processing component 602 may include one or more modules that facilitate the interaction between the processing component 602 and other components. For instance, the processing component 602 may include a multimedia module to facilitate the interaction between the multimedia component 608 and the processing component 602.

The memory 604 is configured to store various types of data to support the operation of the device 600. Examples of such data include instructions for any applications or methods operated on the device 600, contact data, phonebook data, messages, pictures, video, etc. The memory 604 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 606 provides power to various components of the device 600. The power component 606 may include a power management system, one or more power sources, and any other components associated with the generation, management, and distribution of power in the device 600.

The multimedia component 608 includes a screen providing an output interface between the device 600 and the user. In some embodiments, the screen may include a liquid crystal display (LCD) and a touch panel. If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 608 includes a front camera and/or a rear camera. The front camera and the rear camera may receive an external multimedia datum while the device 600 is in an operation mode, such as a photographing mode or a video mode. Each of the front camera and the rear camera may be a fixed optical lens system or have focus and optical zoom capability.

The audio component 610 is configured to output and/or input audio signals. For example, the audio component 610 includes a microphone configured to receive an external audio signal when the device 600 is in an operation mode, such as a call mode, a recording mode, and a voice recognition mode. The received audio signal may be further stored in the memory 604 or transmitted via the communication component 616. In some embodiments, the audio component 610 further includes a speaker to output audio signals.

The I/O interface 612 provides an interface between the processing component 602 and peripheral interface modules, such as a keyboard, a click wheel, buttons, and the like. The buttons may include, but are not limited to, a home button, a volume button, a starting button, and a locking button.

The sensor component 614 includes one or more sensors to provide status assessments of various aspects of the device 600. For instance, the sensor component 614 may detect an open/closed status of the device 600, relative positioning of components, e.g., the display and the keypad, of the device 600, a change in position of the device 600 or a component of the device 600, a presence or absence of user contact with the device 600, an orientation or an acceleration/deceleration of the device 600, and a change in temperature of the device 600. The sensor component 614 may include a proximity sensor configured to detect the presence of nearby objects without any physical contact. The sensor component 614 may also include a light sensor, such as a CMOS or CCD image sensor, for use in imaging applications. In some embodiments, the sensor component 614 may also include an accelerometer sensor, a gyroscope sensor, a magnetic sensor, a pressure sensor, or a temperature sensor.

The communication component 616 is configured to facilitate communication, wired or wirelessly, between the device 600 and other devices. The device 600 can access a wireless network based on a communication standard, such as WiFi, 3G or 4G or a combination thereof. In one exemplary embodiment, the communication component 616 receives a broadcast signal or broadcast associated information from an external broadcast management system via a broadcast channel. In one exemplary embodiment, the communication component 616 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth technology, and other technologies.

In exemplary embodiments, the device 600 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer-readable storage medium including instructions, such as included in the memory 604, executable by the processor 620 in the device 600, for performing methods consistent with embodiments of the present disclosure. For example, the non-transitory computer-readable storage medium may be a ROM, a RAM, a CD-ROM, a magnetic tape, a floppy disc, an optical data storage device, or the like.

According to the present disclosure, page display can be adjusted according to a user demand, and the user's need for different page display modes can be satisfied.

Other embodiments of the disclosure will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for adjusting page display on a terminal, comprising:
acquiring, according to a user demand on page display, a first logic density corresponding to the user demand, the first logic density being defined in an operating system of the terminal;
acquiring a second logic density of an application program to be displayed, the second logic density being defined in the application program;
determining a scaling factor of elements in a page of the application program according to the first logic density and the second logic density; and
scaling the elements in the page according to the scaling factor.

2. The method according to claim 1, wherein determining the scaling factor includes determining the scaling factor as a ratio of the first logic density to the second logic density.

3. The method according to claim 1, wherein acquiring the first logic density includes selecting, according to a setting for a layout size of a page layout from a user, the first logic density corresponding to the layout size.

4. The method according to claim 3, further comprising:
setting at least two page-layout options, each of the page-layout options containing an identification indicating a layout size corresponding to the page-layout option;
wherein selecting the first logic density corresponding to the layout size set by the user includes:
displaying the page-layout options;
determining which one of the page-layout options is selected by the user; and
choosing the first logic density corresponding to the selected page-layout option as the first logic density corresponding to the layout size.

5. The method according to claim 1, wherein acquiring the first logic density includes selecting, according to a model or a screen size of the terminal, the first logic density corresponding to the model or the screen size of the terminal.

6. A terminal, comprising:
a processor; and
a memory storing instructions that, when executed by the processor, cause the processor to:
acquire, according to a user demand on page display, a first logic density corresponding to the user demand, the first logic density being defined in an operating system of the terminal;
acquire a second logic density of an application program to be displayed, the second logic density being defined in the application program;
determine a scaling factor of elements in a page of the application program according to the first logic density and the second logic density; and
scale the elements in the page according to the scaling factor.

7. The device according to claim 6, wherein the instructions further cause the processor to:
determine the scaling factor as a ratio of the first logic density to the second logic density.

8. The device according to claim 6, wherein the instructions further cause the processor to:
select, according to a setting for a layout size of a page layout from a user, the first logic density corresponding to the layout size.

9. The device according to claim 8, wherein the instructions further cause the processor to:
set at least two page-layout options, each of the page-layout options containing an identification indicating a layout size corresponding to the page-layout option;
display the page-layout options;
determine which one of the page-layout options is selected by the user; and
choose the first logic density corresponding to the selected page-layout option as the first logic density corresponding to the layout size.

10. The device according to claim 6, wherein the instructions further cause the processor to:
select, according to a model or a screen size of the terminal, the first logic density corresponding to the model or the screen size of the terminal.

11. A non-transitory computer-readable storage medium storing instructions that, when being executed by a processor of a terminal, cause the terminal to:
acquire, according to a user demand on page display, a first logic density corresponding to the user demand, the first logic density being defined in an operating system of the terminal;
acquire a second logic density of an application program to be displayed, the second logic density being defined in the application program;
determine a scaling factor of elements in a page of the application program according to the first logic density and the second logic density; and
scale the elements in the page according to the scaling factor.

12. The non-transitory computer-readable storage medium according to claim 11, wherein the instructions further cause the terminal to:
determine the scaling factor as a ratio of the first logic density to the second logic density.

13. The non-transitory computer-readable storage medium according to claim 11, wherein the instructions further cause the terminal to:
select, according to a setting for a layout size of a page layout from a user, the first logic density corresponding to the layout size.

14. The non-transitory computer-readable storage medium according to claim 13, wherein the instructions further cause the terminal to:
set at least two page-layout options, each of the page-layout options containing an identification indicating a layout size corresponding to the page-layout option;
display the page-layout options;
determine which one of the page-layout options is selected by the user; and
choose the first logic density corresponding to the selected page-layout option as the first logic density corresponding to the layout size.

15. The non-transitory computer-readable storage medium according to claim 11, wherein the instructions further cause the terminal to:
select, according to a model or a screen size of the terminal, the first logic density corresponding to the model or the screen size of the terminal.
